(19) United States
(12) Patent Application Publication
(10) Pub. No.: US 2016/0179576 A1
(43) Pub. Date: Jun. 23, 2016

(54) QUOTA BASED RESOURCE MANAGEMENT

(71) Applicant: EMC Corporation, Hopkinton, MA (US)

(72) Inventors: Yingchao Zhou, Beijing (CN); Weigang Zhong, Beijing (CN); Donglei Wang, Beijing (CN); Marvin Fan Zhang, Beijing (CN)

(21) Appl. No.: 14/971,076

(22) Filed: Dec. 16, 2015

(30) Foreign Application Priority Data
Dec. 19, 2014 (CN) 201410813708.9

(51) Int. Cl. G06F 9/50; G06F 17/30

(52) U.S. Cl. CPC G06F 9/50; G06F 17/30085

(57) ABSTRACT

Embodiments of the present invention provide a quota-based resource management method, computer program product and apparatus for configuring a resource quota for each user entity of a plurality of user entities based on a first policy or a second policy, the first policy indicating that the resource quota is to be configured using a percentage of an amount of resources allowed to be configured with respect to an amount of all resources, the second policy indicating that the resource quota is to be configured using the amount of resources allowed to be configured; and applying the resource quota according to the first policy or the second policy, and can be adapted to dynamic changes of the amount of resources.

### RELATED APPLICATION

This application claim priority from Chinese Patent Application Number CN201410813708.9, titled “METHOD AND APPARATUS FOR MANAGING RESOURCES BASED ON QUOTA” filed on Dec. 19, 2014 at the State Intellectual Property Office, China, the contents of which are herein incorporated by reference in entirety.

### FIELD OF THE INVENTION

Embodiments of the present disclosure relate to resource management.

### BACKGROUND OF THE INVENTION

In the field of computers, quota may be referred to generally as a mechanism for tracking and controlling resource consumption of user entities, so as to prevent resource over-consumption and also make/generate statistics on resource allocation and report resource allocations. Typically a resource may include, for example, disk space, memory, CPU, etc.; and user entities may include, for example, individual users, user groups, processes, etc. Consider a file system, for example, where a quota may be used to prevent individual users or user groups from overusing disk space in a file system, especially in multi-user environments.

### SUMMARY OF THE INVENTION

In view of the above and other potential problems, various embodiments of the present disclosure propose a resource management solution that may be adapted to dynamic changes of the amount of resources.

Embodiments of the present disclosure provide a quota-based resource management method that may include configuring a resource quota for each user entity of a plurality of user entities based on a first policy or a second policy, a first policy indicating that a resource quota is to be configured using a percentage of an amount of resources allowed to be configured with respect to an amount of all resources, a second policy indicating that the resource quota is to be configured using the amount of resources allowed to be configured; and applying the resource quota according to the first policy or the second policy.

### BRIEF DESCRIPTION OF THE DRAWINGS

Through the detailed description of some embodiments of the present disclosure in the accompanying drawings, the features, advantages and other aspects of the present disclosure will become more apparent, wherein several embodiments of the present disclosure are shown for the illustration purpose only, rather than for limiting. In the accompanying drawings:

FIG. 1 shows a flowchart of a quota-based resource management method 100 according to one embodiment of the present disclosure;

FIG. 2 shows a block diagram of a quota-based resource management apparatus 200 according to one embodiment of the present disclosure; and

FIG. 3 shows a schematic block diagram of a computer system 300 which is applicable to implement the embodiments of the present disclosure.

### DETAILED DESCRIPTION OF EMBODIMENTS

With reference to the figures, detailed description is presented below to various embodiments of the present disclosure. The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In this disclosure, “resources” may include, but are not limited to, disk space, memory, CPU, and the like. In addition, “user entities” may include, but are not limited to, individual users, user groups, processes, and the like.

In one embodiment, to apply quota mechanisms, a storage administrator may be required to set quota limits for individual users or user groups. In a further embodiment, usually, setting a quota may be based on current capacity configured for a file system. In a further embodiment, for example, suppose the capacity of a file system is 10 terabytes, and if there are three individual users sharing the file system: User1 a senior engineer, User2 a junior engineer and User3 an intern engineer, in this case, a storage administrator might set quota limits in a file system to be 5 terabytes for User1, 4 terabytes for User2 and 1 terabytes for User3.

In certain embodiment, however, under different circumstances/conditions, a file system's overall capacity may be re-sized. In a further embodiment, for example, if new disks are installed to a file system, the file system may be expanded accordingly. In a further embodiment, many modern file systems may even support thin provisioning, which may automatically re-size a file system's capacity based on actual storage consumption. In a further embodiment, where a file system's capacity may be expanded or shrunk, a storage administrator may have to change quota configuration for user entities, otherwise storage capacity may be overused or underutilized. In a further embodiment, considering the above example, when a file system of 10 terabytes is shrunk to 4 terabytes, if a storage administrator does not change quota settings, a junior engineer may use up the entire capacity and leave nothing to other users in the group. Therefore, there is a need for an efficient resource management solution that may be adapted to dynamic changes of resources.

Embodiments of the present disclosure provide a quota-based resource management system and method. One embodiment may include configuring a resource quota for each user entity of a plurality of user entities based on a first policy or a second policy. A further embodiment may include a first policy indicating that a resource quota is to be configured using a percentage of an amount of resources allowed to be configured with respect to an amount of all resources. A further embodiment may include a second policy indicating that a resource quota is to be configured using an amount of resources allowed to be configured. A further embodiment may include applying a resource quota according to a first policy or a second policy

In one embodiment, configuring a resource quota for each user entity of a plurality of user entities based on a first policy or a second policy may include creating a quota database record for the each user entity. In a further embodiment a quota database record may at least include: an identifier field for identifying a user entity to which the quota database record is directed. A further embodiment may include a first resource upper limit field for indicating a resource upper limit which may be allowed to be allocated to a respective user entity. A further embodiment may include a resource usage field for indicating current resource usage of a respective user entity. A further embodiment may include a policy field for indicating whether a resource upper limit is configured for a respective user entity based on a first policy or a second policy.

In one embodiment, if the resource quota may be configured for the respective user entity based on the first policy, content of a first resource upper limit field indicates a percentage of a maximum amount of resources which may be allowed to be allocated to a respective user entity with respect to an amount of all resources.

In one embodiment, applying a resource quota according to a first policy or a second policy may include: in response to receiving a resource allocation request from a user entity, checking a policy field of a quota database record for a user entity so as to determine whether a resource quota for the user entity is configured based on a first policy or a second policy. A further embodiment may include determining according, at least in part, to a determined policy, whether or not to allocate a requested resource to a user entity.

In one embodiment, determining according, at least in part, to a determined policy, whether or not to allocate the requested resource to a user entity may include: if a resource quota may be configured for a user entity based on a first policy, determining according, at least in part, to a first policy, whether or not to allocate a requested resource to a user entity.

In one embodiment, determining according, at least in part, to a first policy, whether or not to allocate a requested resource to a user entity may include: calculating/computing a maximum amount of resources which may be allowed to be allocated to the user entity, based on content in a first resource upper limit field of a quota database record for the user entity. A further embodiment may include calculating/computing a sum of current resource usage of a user entity and an amount of a requested resources; comparing a sum with a maximum amount of resources. A further embodiment may include allocating a requested resource to a user entity in response to a sum being not exceeding a maximum amount of resources.

In one embodiment, a quota database record for each user entity may further include a second resource upper limit field for indicating a resource threshold which may be allowed to be allocated to a respective user entity. A further embodiment may include in response to current resource usage of a respective user entity exceeding a resource threshold, sending a message to a respective user entity to warn that a current resource usage of a respective user entity may exceed a resource upper limit

In one embodiment, applying a resource quota according to a first policy or a second policy may include: specifying a format of a quota report. A further embodiment may include sending a quota reporting request to a user entity so as to request a user entity reporting information in a quota database record for a user entity using a specified format.

In one embodiment, a specified format of a quota format may include one of: a percentage format, indicating that a user entity should report content in an identifier field, may use a percentage of a maximum amount of resources which may be allowed to be allocated to a respective user entity with respect to an amount of all resources to report content in a first resource upper limit field, and may use a percentage of an amount of resources which may have been used by a respective user entity with respect to an amount of all resources to report content in a resource usage field. A further embodiment may include an amount format, indicating a user entity may report content in an identifier field, may use a maximum amount of resources which may be allowed to be allocated to a respective user entity to report content in a first resource upper limit field. A further embodiment may include use an amount of resources which may have been used by a respective user entity to report content in a resource usage field. A further embodiment may include a default format, indicating a user entity may report contents in all fields of a quota database record for a user entity.

Embodiments of the present disclosure may include a quota-based resource management apparatus. In one embodiment the apparatus may include a quota configuring unit that may be configured to configure a resource quota for each user entity of a plurality of user entities based on a first policy or a second policy. A further embodiment may include a first policy indicating that a resource quota may be configured using a percentage of an amount of resources that may be allowed to be configured with respect to an amount of all resources. A further embodiment may include a second policy indicating that a resource quota may be to be configured using the amount of resources that may be allowed to be configured. A further embodiment may include a quota applying unit that may be configured to apply a resource quota according to a first policy or a second policy.

Embodiments of the present disclosure may include a computer program product, including a computer readable medium, that may be configured to carry computer program code embodied therein and for use with a computer. In a further embodiment, the computer program code may comprise: code for configuring a resource quota for each user entity of a plurality of user entities based on a first policy or a second policy. A further embodiment may include a first policy indicating that a resource quota may be configured using a percentage of an amount of resources that may be allowed to be configured with respect to an amount of all resources. A further embodiment may include a second policy indicating that a resource quota may be configured using an amount of resources that may be allowed to be configured. A further embodiment may include code for applying the resource quota according to the first policy or the second policy.

Embodiments of the present disclosure may offer two options of quota configuration for end users (e.g. storage administrators), so that end users may configure and apply resource quotas based on a policy. In a further embodiment, end users may choose one of “percentage policy” and/or “amount policy” to implement quota configuration according to a usage environment and actual needs. In a further embodiment, the resource management solution of the present disclosure may be adapted to dynamic changes of the amount of resources. In a further embodiment, where a storage administrator uses quota reporting to learn resource consumption, showing a percentage of an amount of resources that may have been used by a user entity with respect to a total amount of resources might be more straightforward and convenient in some cases.

In one embodiment, description is presented for an existing quota-based resource management method by means of a file system. In a further embodiment, in existing quota-based resource management method, resource quotas may be configured for user entities by using the exact amount of resources. In a further embodiment, to implement a quota-based resource management method, typically, a file system may create and maintain a quota database for user entities so as to track and control resource allocation among user entities. In a further embodiment, in a quota database, one quota database record may be created for each user entity to which resources may be allocated.

Table 1 shows an exemplary structure of the quota database.

TABLE 1

| UserID | CurrentSpaceUsage | SoftLimit | HardLimit |
|---|---|---|---|
| 100 | 100 G | 100 G | 150 G |
| 106 | 230 G | 300 G | 400 G |
| 109 | 160 G | 150 G | 200 G |
| . . . | . . . | . . . | . . . |

As shown in Table 1, each quota database record in the quota database, i.e. each row in Table 1 includes at least the following three fields:
(1) UserID: identifier field, for identifying a user entity to which the quota database record is directed;
(2) HardLimit: first resource upper limit field, also referred to as hard upper limit field, for indicating the upper limit of resources which are allowed to be allocated to a respective user entity;
(3) CurrentSpaceUsage: resource usage field, for indicating current resource usage of a respective user entity.

In addition, each quota database record in the quota database may optionally include a field as below:
SoftLimit: second resource upper limit field, also referred to as soft upper limit field, for indicating a resource threshold that may be allowed to be allocated to a respective user entity. When current resource usage of a respective user entity exceeds the resource threshold, a message is sent to the respective user entity to warn that current resource usage of the respective user entity will exceed the resource upper limit (i.e. the value in the hard upper limit field).

As seen from Table 1, values in both HardLimit and SoftLimit fields represent exact amounts of resources. As shown in Table 1, regarding a user entity having UserID 100, the disk space that may be allowed to be allocated to the user entity is 150G, and current disk space usage of user entity 100 is 100G. When the current disk space usage of UserID 100 exceeds a threshold 100G specified by the SoftLimit field, a message will be sent to UserID 100 warning the user that the current disk space usage will exceed the disk space upper limit specified by the HardLimit field.

In one embodiment, when a user entity may require to perform modification operations in a file system, for example, when a user entity may require to perform such operations in a file system as writing/removing/chown (change owner)/chgrp (change group), user entity may send a disk space allocation request to a system. In a further embodiment, in response to receiving a disk space allocation request from a user entity, a system will look up a quota database record, which may be created for the user entity, in the quota database. In a further embodiment, the system may calculate/compute a sum of a value in a CurrentSpaceUsage filed and an amount of requested disk space, and may compare the sum with a disk space upper limit specified by the HardLimit field. In a further embodiment, if the sum does not exceed a disk space upper limit specified by a HardLimit field, the system may allocate a requested disk space to a user entity; otherwise, the system may reject a user entity's request and return a “quota exceeding” error to the user entity.

The following is an example of pseudo code in a file system's writing path and chown (change owner) path.

Write path:

```
Status write(Inode *file, BlockList *list, ID UserId)
{
......
    FileSystem *fs = file->getFS( );
    QuotaRecord *qr = fs->getQuotaRecord(UserId);
    For each block in list {
        If (qr->CurrentSpaceUsage + blockSize( ) > qr->HardLimit) {
            Return Quota_Exceeded;
        }
        Else {
            Fs->writeBlock(block);
            qr->CurrentSpaceUsage = qr->CurrentSpaceUsage +
            blockSize( );
            If (qr->CurrentSpaceUsage  >  qr->SoftLimit) {
                SendWarningMessage(UserId);
            }
        }
    }
......
}
```

Chown path:

```
    Status chown(Inode *file, ID UserId1, ID UserId2)
    {
    ......
        FileSystem *fs = file->getFS( );
        QuotaRecord *qr1 = fs->getQuotaRecord(UserId1);
        QuotaRecord *qr2 = fs->getQuotaRecord(UserId2);
        If (qr2->CurrentSpaceUsage + file->usedBlocks( ) >
        qr2->HardLimit) {
            Return Quota_Exceeded;
        }
        qr1->CurrentSpaceUsage = qr1->CurrentSpaceUsage −
        file->usedBlocks( );
        qr2->CurrentSpaceUsage = qr2->CurrentSpaceUsage +
        file->usedBlocks( );
        if (qr2->CurrentSpaceUsage > qr->SoftLimit) {
            SendWarningMessage(UserId2);
        }
    ......
}
```

In the above pseudo code, a SendWarningMessage( ) interface will throttle messages to prevent warning messages from being sent to a user entity too frequently.

In one embodiment, in order to track resource consumption of a user entity, a storage administrator may send a quota reporting request via a control path of the file system, requesting a user entity to report information in a quota database record created for a user entity. In a further embodiment, in response, the system may read required information in a quota database record from a quota database and return read information to a storage administrator and a respective user entity.

In one embodiment, where a file system's capacity may be expanded or shrunk, a storage administrator may have to change quota configurations of user entities, otherwise the storage capacity may be overused or underutilized. To this end, various embodiments of the present disclosure propose a resource management solution that may be adapted to dynamically changes of resources and resource amounts, where configuration and application of resource quotas may be implemented based on a policy.

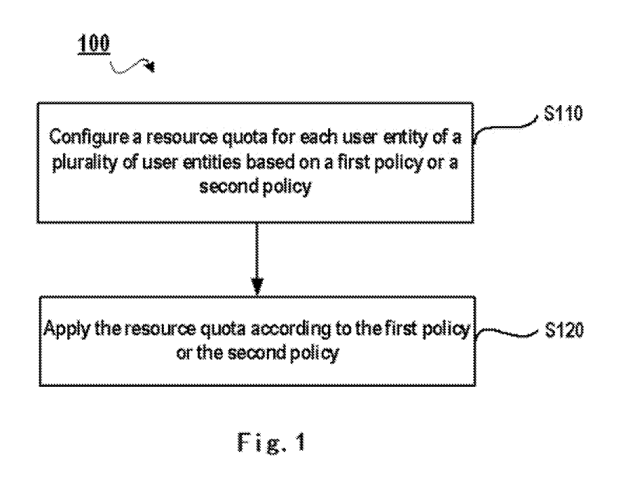

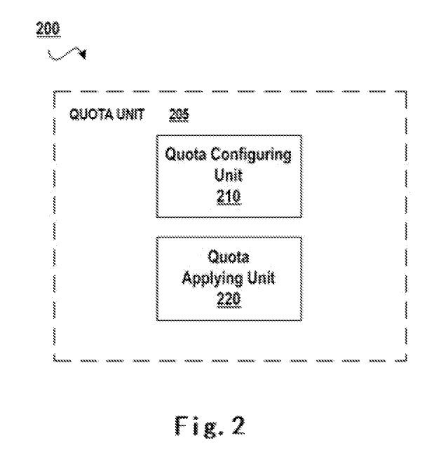

With reference to FIGS. 1 and 2, detailed description is presented below for a quota-based resource management method and apparatus according to the embodiments of the present disclosure.

FIG. 1 shows a flowchart of a quota-based resource management method 100 according to an embodiment of the present disclosure. As shown in FIG. 1, in step S110, a resource quota is configured for each user entity of a plurality of user entities based on a first policy or a second policy. In step S120, the resource quota is applied according to the first policy or the second policy

In one embodiment, a first policy indicate that a resource quota may be configured using a percentage of an amount of resources that may be allowed to be configured with respect to an amount of all resources. A further embodiment may include a second policy that may indicate that a resource quota may be configured using the amount of resources that may be allowed to be configured.

In one embodiment, it may be understood that a first policy may be a new quota configuration policy, and a second policy may be an existing policy for configuring resource quotas for user entities by using the exact amount of resources. In a further embodiment, for purpose of description, hereinafter first policy is referred to as “percentage policy” for short and second policy is referred to as “amount policy”.

The embodiments of the present disclosure may provide two choices of quota configuration for end users (e.g., storage administrator), such that an end users may choose one of “percentage policy” and “amount policy” to implement quota configuration according to a usage environment and actual needs. In one embodiment, for example, many end users may have developed facilities/tools, scripts and the like to manage quotas using an existing “amount policy”. In an embodiment, in the present solution an end users may not be compelled to use a “percentage policy” for quota management, but they may still use existing facilities/tools, scripts and the like to adopt an “amount policy” instead of developing new facilities/tools, scripts and the like. In a further embodiment, additionally, in some cases, the only purpose of expanding a file system may be to support new user entities, wherein using an existing “amount policy” to manage quotas might be advantageous.

In the embodiments of the present disclosure, in order to use “percentage policy” or “amount policy” to implement quota management, some changes might be made to quota database records in the quota database shown in Table 1. Table 2 below shows an exemplary structure of a quota database according to one embodiment of the present disclosure.

TABLE 2

| UserID | CurrentSpaceUsage | SoftLimit | HardLimit | Policy |
|---|---|---|---|---|
| 100 | 100 G | 100 G | 150 G | 0 |
| 106 | 230 G | 30 | 40 | 1 |
| 109 | 160 G | 15 | 20 | 1 |
| . . . | . . . | . . . | . . . | . . . |

As shown in Table 2, each quota database record in the quota database, i.e. each row in Table 2 at least comprises the following four fields:
(1) UserID: identifier field, for identifying a user entity to which the quota database record is directed;
(2) HardLimit: first resource upper limit field, also referred to as hard upper limit field, for indicating the upper limit of resources which are allowed to be allocated to a respective user entity;
(3) CurrentSpaceUsage: resource usage field, for indicating current resource usage of a respective user entity;
(4) Policy: policy field, for indicating whether the resource upper limit configured for a user entity is based on the first policy or the second policy.

As seen from a comparison of Table 2 with Table 1, a new field Policy has been added to Table 2. In one embodiment, a value in the field Policy may be a binary value, e.g. 1 or 0. In a further embodiment, for example, policy “1” may mean that the “percentage policy” may be used to configure quotas for respective user entities, and policy “0” may mean that the “amount policy” may be used to configure quotas for respective user entities.

In addition, each quota database record in the quota database may optionally include a field as below:
SoftLimit: second resource upper limit field, also referred to as soft upper limit field, for indicating a resource threshold which may be allowed to be allocated to a respective user entity. When current resource usage of a respective user entity exceeds the resource threshold, a message may be sent to the respective user entity to warn that current resource usage of the respective user entity will exceed the resource upper limit (i.e. the value in the hard upper limit field).

As seen from Table 2, values in HardLimit and SoftLimit fields represent exact amounts or percentages of the disk space for different user entities. In one embodiment, for example, regarding a user entity with UserID of 100, a value in the field Policy of a quota database record is 0, which means the “amount policy” may be used to configure quotas for the user entity; therefore, the disk space that may be allocated to the user entity may be 150G. In a further embodiment, when current disk space usage of user entity 100 exceeds a threshold 100G specified by a SoftLimit field, a message may be sent to user entity 100 to warn that the current disk space usage may exceed the disk space upper limit specified by a HardLimit field. In a further embodiment, additionally, regarding a user entity with UserID of 106, a value in a field Policy of a quota database record is 1, which means the “percentage policy” may be used to configure quotas for a user entity. In a further embodiment, in this case, a value of HardLimit (i.e. 40%) means a percentage of a maximum amount of disk space that may be allowed to be allocated to user entity 106 with respect to a total amount of disk space. In a further embodiment, when current disk space usage of user entity 106 exceeds a threshold (i.e. 30%) specified by SoftLimit, a message may be sent to user entity 106 to warn that a current disk space usage may exceed the disk space upper limit specified by HardLimit.

In one embodiment, when a user entity may require to perform modification operations in a file system, for example, when a user entity may require to perform such operations in the file system as writing/removing/chown (change owner)/chgrp (change group), the user entity may send a disk space allocation request to a system. In a further embodiment, in response to receiving a disk space allocation request from a user entity, a system may look up a quota database record, which may created for a user entity, in a quota database. In a further embodiment, a policy field of a quota database record for a user entity may be checked to determine whether configuring a resource quota for a user entity is based on the “percentage policy” or “amount policy”. In a further embodiment, it may be determined according, at least in part, to a determined policy whether or not to allocate a requested resource to a user entity. In a further embodiment, for example, where a resource quota may be configured for a user entity based on a “percentage policy”, it may be determined according, at least in part, to a “percentage policy” whether or not to allocate a requested resource to a user entity.

In one embodiment, where it may be determined according to a “percentage policy” whether or not allocate a requested resource to a user entity, operations may be performed as below: calculating a maximum amount of resources which may be allowed to be allocated to the user entity, based on a value in HardLimit of a quota database record created for a user entity; calculating a sum of current resource usage of a user entity (i.e. a value in the field CurrentSpaceUsage) and an amount of requested resources; and comparing the sum with a maximum amount of resources; if the sum does not exceed a maximum amount of resources, a requested resource may be allocated to a user entity, otherwise a request from a user entity may be rejected and a “quota exceeding” error may be returned to a user entity. In a further embodiment, before allocating a requested resource to a user entity, a value of CurrentSpaceUsage may be updated with the sum of current resource usage of a user entity and an amount of requested resources, so as to ensure consistency between quota record information and a modification operation.

The following is an example of pseudo code in a file system's writing path according to one embodiment of the present disclosure.
Pseudo code in the writing path:

```
    Status write(Inode *file, BlockList *list, ID UserId)
    {
    ......
        FileSystem *fs = file->getFS( );
        QuotaRecord *qr = fs->getQuotaRecord(UserId);
        ULONG64 SoftLimit = qr->SoftLimit, HardLimit =
        qr->HardLimit;
        If (qr->policy == PERCENTAGE_POLICY) { //
        PERCENTAGE_POLICY == 1
          SoftLimit = fs->getCapacity( ) * qr->SoftLimit / 100;
          HardLimit = fs->getCapacity( ) * qr->HardLimit / 100;
        }
        For each block in list {
          If (qr->CurrentSpaceUsage + blockSize( ) > HardLimit) {
              Return Quota_Exceeded;
          }
          Else {
              Fs->writeBlock(block);
              If (qr->CurrentSpaceUsage  >  SoftLimit) {
                  SendWarningMessage(UserId);
              }
          }
      }
  ......
}
```

As seen from comparison of the above pseudo code with the pseudo code in the writing path described with reference to Table 1, there are differences between the above pseudo code in lines 6-10, 12 and 17 and corresponding parts of the pseudo code described with reference to Table 1.

The following is an example of pseudo code in a file system's chown (change owner) path according to one embodiment of the present invention.
Pseudo code in chown path:

```
    Status chown(Inode *file, ID UserId1, ID UserId2)
    {
    ......
      FileSystem *fs = file->getFS( );
      QuotaRecord *qr1 = fs->getQuotaRecord(UserId1);
      QuotaRecord *qr2 = fs->getQuotaRecord(UserId2);
      ULONG64 SoftLimit = qr->SoftLimit, HardLimit =
      qr->HardLimit;
      If (qr->policy == PERCENTAGE_POLICY)
      {//PERCENTAGE_POLICY == 1
          SoftLimit = fs->getCapacity( ) * qr->SoftLimit / 100;
          HardLimit = fs->getCapacity( ) * qr->HardLimit / 100;
      }
      If (qr2->CurrentSpaceUsage + file->usedBlocks( ) > HardLimit) {
          Return Quota_Exceeded;
      }
      qr1->CurrentSpaceUsage = qr1->CurrentSpaceUsage −
      file->usedBlocks( );
      qr2->CurrentSpaceUsage = qr2->CurrentSpaceUsage +
      file->usedBlocks( );
      if (qr2->CurrentSpaceUsage > SoftLimit) {
          SendWarningMessage(UserId2);
      }
  ......
}
```

As seen from comparison of the above pseudo code with the pseudo code in the chown path described with reference to Table 1, there are differences between the above pseudo code in lines 7-12 and 17 and corresponding parts of the pseudo code described with reference to Table 1.

In one embodiment, in order to track resource consumption of a user entity, a storage administrator may request a user entity to report information in a quota database record created for the user entity. According to one embodiment of the present disclosure, a storage administrator may specify a format of a quota report and may send a quota reporting request to a user entity, requesting a user entity to use a specified format to report information in a quota database record created for the user entity.

According to one embodiment of the present disclosure, a format of a quota report comprises one of the following:
(1) a percentage format, indicating that a user entity may report content in the identifier field, may use a percentage of a maximum amount of resources that may be allowed to be allocated to a respective user entity with respect to a total amount of all resources to report content in a first resource upper limit field, and may use a percentage of an amount of resources that may have been used by a respective user entity with respect to an amount of all resources to report content in a resource usage field;
(2) an amount format, indicating a user entity may report content in an identifier field, may use a maximum amount of resources that may be allowed to be allocated to a respective user entity to report content in a first resource upper limit field, and may use an amount of resources that may have been used by a respective user entity to report content in a resource usage field; and
(3) a default format, indicating a user entity may report contents in all fields of a quota database record for a user entity.

In some embodiment, it may be understood before information in each quota record may be returned to a control path, recorded information may be translated to a format specified by a storage administrator.

Table 3 shows below an example of reporting quota record information in the “percentage format”; Table 4 shows below an example of reporting quota record information in the “amount format”; Table 5 shows below an example of reporting quota record information in the “default format”.

TABLE 3

| UserID | CurrentSpaceUsage | SoftLimit | HardLimit |
|---|---|---|---|
| 100 | 10% | 10% | 15% |
| 106 | 23% | 30% | 40% |
| 109 | 16% | 15% | 20% |
| . . . | . . . | . . . | . . . |

TABLE 4

| UserID | CurrentSpaceUsage | SoftLimit | HardLimit |
|---|---|---|---|
| 100 | 100 G | 100 G | 150 G |
| 106 | 230 G | 300 G | 400 G |
| 109 | 160 G | 150 G | 200 G |
| . . . | . . . | . . . | . . . |

TABLE 5

| UserID | CurrentSpaceUsage | SoftLimit | HardLimit | Policy |
|---|---|---|---|---|
| 100 | 100 G | 100 G | 150 G | Amount |
| 106 | 23% | 30% | 40% | Percentage |
| 109 | 16% | 15% | 20% | Percentage |
| . . . | . . . | . . . | . . . | . . . |

In one embodiment, a storage administrator may change a user entity's quota configuration policy at any time through a control path command or GUI operation. In one embodiment, when a storage administrator changes a user entity's quota configuration policy from “amount policy” to “percentage policy”, if a storage administrator provides new percentage value(s) (1-100) for soft upper limit or hard upper limit or both, the new percentage value(s) may be used as new upper limit(s). In a further embodiment, a system may use an existing soft upper limit or hard upper limit value that may divide a current file system's capacity to get a percentage value.
In one embodiment when a storage administrator changes a user entity's quota configuration policy from “percentage policy” to “amount policy”, if a storage administrator provides new exact values for soft upper limit or hard upper limit or both, the new exact value(s) may be used as new upper limit(s). In a further embodiment, a system may use a current percentage value to multiply a current file system's capacity to get an exact amount.

It should be understood that although the present disclosure has been described above by means of disk space management of a file system for the only purpose of illustration, the scope of the present disclosure is not limited thereto. The present application is applicable to any quota-based resource management environment. For example, the present disclosure may also be applied to other storage container than the file system, such as a storage pool resulting from binding several storage addresses together. In addition, the present disclosure may further be applied to other resource management than the disk space management, such as memory management.

The embodiments of the present disclosure further provide a quota-based resource management apparatus. FIG. 2 shows a block diagram of a quota-based resource management apparatus 200 according to an embodiment of the present invention. As shown in FIG. 2, apparatus 200 comprises: quota configuring unit 210 configured to configure a resource quota for each user entity of a plurality of user entities based on a first policy or a second policy, the first policy indicating that the resource quota is to be configured using a percentage of an amount of resources allowed to be configured with respect to an amount of all resources, the second policy indicating that the resource quota is to be configured using the amount of resources allowed to be configured; and quota applying unit 220 configured to apply the resource quota according to the first policy or the second policy. Alternatively, a Quota Unit 205, which is a single unit, may be configured to perform the tasks associated with quota configuring unit 210 and quota applying unit 220.

In one embodiment, quota configuring unit 210 may be further configured to create a quota database record for each user entity. In a further embodiment, a quota database record at least comprises: an identifier field for identifying a user entity to which a quota database record may be directed; a first resource upper limit field for indicating a resource upper limit which may be allowed to be allocated to a respective user entity; a resource usage field for indicating current resource usage of a respective user entity; and a policy field for indicating whether a resource upper limit may be configured for a respective user entity based on a first policy or a second policy.

In one embodiment, if a resource quota may be configured for a respective user entity based on a first policy, content of a first resource upper limit field may indicate a percentage of a maximum amount of resources which may be allowed to be allocated to a respective user entity with respect to an amount of all resources.

In one embodiment, quota applying unit 220 may be further configured, in response to receiving a resource allocation request from a user entity, to check a policy field of a quota database record for a user entity so as to determine whether a resource quota for a user entity is configured based on a first policy or a second policy. A further embodiment may include determining according, at least in part, to a determined policy, whether or not to allocate a requested resource to a user entity.

In one embodiment, quota applying unit 220 may be further configured to determine according, at least in part, to a first policy, whether or not to allocate a requested resource to a user entity if a resource quota may be configured for a user entity based on a first policy.

In one embodiment, a quota applying unit 220 may be further configured: to calculate a maximum amount of resources which may be allowed to be allocated to a user entity, based on content in a first resource upper limit field of a quota database record for a user entity. A further embodiment may include calculating a sum of current resource usage of a user entity and an amount of requested resources. A further embodiment may include comparing the sum with a maximum amount of resources. A further embodiment may include allocating a requested resource to a user entity in response to the sum being not exceeding a maximum amount of resources.

In one embodiment, a quota database record created for each user entity further comprises a second resource upper limit field for indicating a resource threshold which may be allowed to be allocated to a respective user entity.

In one embodiment, quota applying unit 220 may be further configured to specify a format of a quota report; and to send a quota reporting request to a user entity so as to request the user entity reporting information in a quota database record for a user entity using a specified format.

In one embodiment, a specified format of a quota format comprises one of:

a percentage format, indicating that a user entity may report content in an identifier field, may use a percentage of a maximum amount of resources that may be allowed to be allocated to a respective user entity with respect to an amount of all resources to report content in a first resource upper limit field, and may use a percentage of an amount of resources that may have been used by a respective user entity with respect to a n amount of all resources to report content in a resource usage field;

an amount format, indicating a user entity may report content in an identifier field, may use a maximum amount of resources that may be allowed to be allocated to a respective user entity to report content in a first resource upper limit field, and may use an amount of resources that may have been used by a respective user entity to report content in a resource usage field; and

a default format, indicating a user entity may report contents in all fields of a quota database record for a user entity.

The embodiments of the present disclosure further provide a computer program product, comprising a computer readable medium which carries computer program code embodied therein and for use with a computer, the computer program code comprising: code for configuring a resource quota for each user entity of a plurality of user entities based on a first policy or a second policy, the first policy indicating that the resource quota is to be configured using a percentage of an amount of resources allowed to be configured with respect to an amount of all resources, the second policy indicating that the resource quota is to be configured using the amount of resources allowed to be configured; and code for applying the resource quota according to the first policy or the second policy.

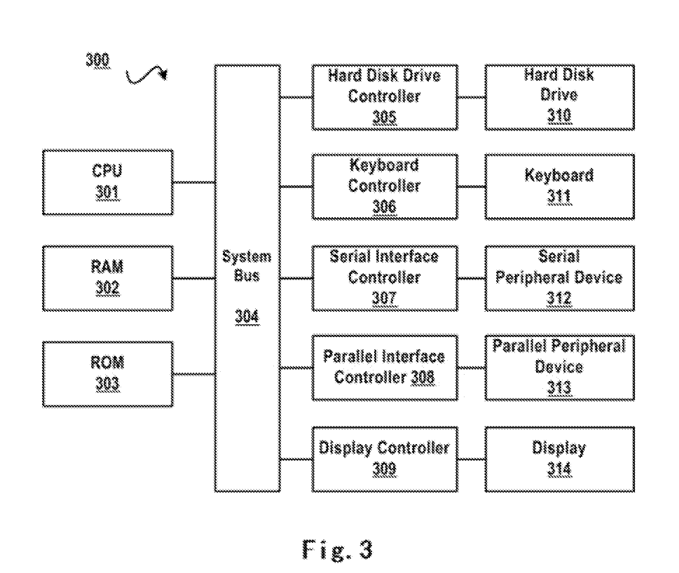

With reference to FIG. 3, this figure shows a schematic block diagram of a computer system 300 which is applicable to implement the embodiments of the present disclosure. For example, computer system 300 shown in FIG. 3 may be used for implementing above-described quota-based resource management apparatus 200.

As shown in FIG. 3, computer system 300 includes: CPU (Central Processing Unit) 301, RAM (Random Access Memory) 302, ROM (Read Only Memory) 303, system bus 304, hard disk drive controller 305, keyboard controller 306, serial interface controller 307, parallel interface controller 308, display controller 309, hard disk drive 310, keyboard 311, serial peripheral device 312, parallel peripheral device 313 and display 314. Among these devices, connected to system bus 304 are CPU 301, RAM 302, ROM 303, hard disk drive controller 305, keyboard controller 306, serial interface controller 307, parallel interface controller 308 and display controller 309. Hard disk drive 310 is coupled to hard disk drive controller 305; keyboard 311 is coupled to keyboard controller 306; serial peripheral device 312 is coupled to serial interface controller 307; and parallel peripheral device 313 is coupled to parallel interface controller 308; and display 314 is coupled to display controller 309. It should be understood that the structural block diagram in FIG. 3 is shown only for illustration purpose, and is not intended to limit the scope of the present invention. In some cases, some devices may be added or reduced as required.

As above mentioned, apparatus 200 may be implemented through pure hardware, for example, chip, ASIC, SOC, etc. Such hardware may be integrated into computer system 300. Besides, the embodiments of the present disclosure may also be implemented in a form of a computer program product. For example, method 100 as described with reference to FIG. 1 may be implemented via a computer program product. This computer program product may be stored in RAM 302, ROM 303, hard disk drive 310 and/or any suitable storage medium as illustrated in FIG. 3, or downloaded to computer system 300 from a suitable location in the network. The computer program product may comprise computer code portions comprising program instructions that may be executed through a suitable processing device (for example, CPU 301 as shown in FIG. 3). The program instruction at least may comprise instructions for implementing the steps of method 100.

It should be noted that, the embodiments of the present disclosure can be implemented in software, hardware or the combination thereof. The hardware part can be implemented by a dedicated logic; the software part can be stored in a memory and executed by a proper instruction execution system such as a microprocessor or a design-specific hardware. One of ordinary skill in the art may understand that the above-mentioned method and system may be implemented with a computer-executable instruction and/or in a processor controlled code, for example, such code is provided on a bearer medium such as a magnetic disk, CD, or DVD-ROM, or a programmable memory such as a read-only memory (firmware) or a data bearer such as an optical or electronic signal bearer. The apparatuses and their modules in the present disclosure may be implemented by hardware circuitry of a very large scale integrated circuit or gate array, a semiconductor such as logical chip or transistor, or a programmable hardware device such as a field-programmable gate array or a programmable logical device, or implemented by software executed by various kinds of processors, or implemented by combination of the above hardware circuitry and software such as firmware.

The communication network as mentioned in this specification may comprise various kinds of networks, including but not limited to local area network (LAN), wide area network (WAN), an IP-protocol based network (for example Internet), and a peer-to-peer network (for example ad hoc peer network).

It should be noted that although a plurality of units or subunits of the apparatuses have been mentioned in the above detailed depiction, such partitioning is merely non-compulsory. In actuality, according to the embodiments of the present disclosure, the features and functions of two or more units above described may be embodied in one unit. On the contrary, the features and functions of one unit above described may be further partitioned to be embodied in more units.

Besides, although operations of the present methods are described in a particular order in the drawings, it does not require or imply that these operations must be performed according to this particular order, or a desired outcome can only be achieved by performing all shown operations. On the contrary, the execution order for the steps as depicted in the flowcharts may be varied. Additionally or alternatively, some steps may be omitted, a plurality of steps may be merged into one step for execution, and/or a step may be divided into a plurality of steps for execution.

Although the present disclosure has been depicted with reference to a plurality of embodiments, it should be understood that the present disclosure is not limited to the disclosed embodiments. On the contrary, the present disclosure intends to cover various modifications and equivalent arrangements included in the spirit and scope of the appended claims. The scope of the appended claims meets the broadest explanations and covers all such modifications and equivalent structures and functions.

What is claimed is:

1. A quota-based resource management method, comprising:
configuring a resource quota for each user entity of a plurality of user entities based at least on one of a first policy or a second policy,
the first policy indicating that the resource quota is to be configured using a percentage of an amount of resources allowed to be configured with respect to an amount of overall resources,
the second policy indicating that the resource quota is to be configured using the amount of resources allowed to be configured; and
applying the resource quota for each user entity according to the first policy or the second policy.

2. The method according to claim 1, wherein configuring a resource quota for each user entity of a plurality of user entities based on a first policy or a second policy further comprises:
creating a quota database record for the user entity, the quota database record at least comprising:
an identifier field for identifying a respective user entity to which the quota database record is directed;
a first resource upper limit field for indicating a resource upper limit which is allowed to be allocated to the respective user entity;
a resource usage field for indicating current resource usage of the respective user entity; and
a policy field for indicating whether the resource upper limit is configured for the respective user entity based on the first policy or the second policy.

3. The method according to claim 2, wherein if the resource quota is configured for the respective user entity based on the first policy, content of the first resource upper limit field indicates a percentage of a maximum amount of resources which are allowed to be allocated to the respective user entity with respect to the amount of overall resources.

4. The method according to claim 3, wherein applying the resource quota according to the first policy or the second policy comprises:
in response to receiving a resource allocation request from the user entity, checking a policy field of a quota database record for the user entity so as to determine whether the resource quota for the user entity is configured based on the first policy or the second policy; and
defining according, at least in part, to the determination of the resource quota being configured on the first policy or the second policy, whether or not to allocate the requested resource to the user entity.

5. The method according to claim 4, wherein defining according, at least in part, determination of the resource quota being configured on the first policy or the second policy, whether or not to allocate the requested resource to the user entity further comprises:
if the resource quota is configured for the user entity based on the first policy, determining according, at least in part, to the first policy, whether or not to allocate the requested resource to the user entity.

6. The method according to claim 5, wherein determining according, at least in part, to the first policy, whether or not to allocate the requested resource to the user entity comprises:
computing a maximum amount of resources which are allowed to be allocated to the user entity, based on content in the first resource upper limit field of the quota database record for the user entity;
computing a sum of current resource usage of the user entity and an amount of the requested resources;
comparing the sum with the maximum amount of resources; and
allocating the requested resources to the user entity in response to the sum being not exceeding the maximum amount of resources.

7. The method according to claim 2, wherein the quota database record for each user entity further comprises a second resource upper limit field for indicating a resource threshold which are allowed to be allocated to a respective user entity.

8. The method according to claim 7, further comprising:
in response to current resource usage of the respective user entity exceeding the resource threshold, sending a message to the respective user entity to warn that the current resource usage of the respective user entity will exceed the resource upper limit.

9. The method according to claim 3, wherein applying the resource quota according to the first policy or the second policy comprises:
specifying a format of a quota report; and
sending a quota reporting request to a user entity so as to request the user entity reporting information in the quota database record for the user entity using the specified format.

10. The method according to claim 9, wherein the specified format comprises at least one from the group consisting of:
(i) a percentage format, indicating that the user entity should report content in the identifier field, should use the percentage of the maximum amount of resources which are allowed to be allocated to a respective user entity with respect to the amount of all resources to report content in the first resource upper limit field, and should use the percentage of an amount of resources which have been used by the respective user entity with respect to the amount of all resources to report content in the resource usage field;
(ii) an amount format, indicating the user entity should report content in the identifier field, should use the maximum amount of resources which are allowed to be allocated to the respective user entity to report content in the first resource upper limit field, and should use an amount of resources which have been used by the respective user entity to report content in the resource usage field; and
(iii) a default format, indicating the user entity should report contents in all fields of the quota database record for the user entity.

11. A quota-based resource management apparatus, configured to:
configure a resource quota for each user entity of a plurality of user entities based on at least one of a first policy or a second policy,
the first policy indicating that the resource quota is to be configured using a percentage of an amount of resources allowed to be configured with respect to an amount of overall resources,
the second policy indicating that the resource quota is to be configured using the amount of resources allowed to be configured; and
apply the resource quota for each user entity according to the first policy or the second policy.

12. The apparatus according to claim 11, further configured to:
create a quota database record for the each user entity, the quota database record at least comprising:
an identifier field for identifying the user entity to which the quota database record is directed;
a first resource upper limit field for indicating a resource upper limit which is allowed to be allocated to a respective user entity;
a resource usage field for indicating current resource usage of the respective user entity; and
a policy field for indicating whether the resource upper limit is configured for the respective user entity based on the first policy or the second policy.

13. The apparatus according to claim 12, wherein if the resource quota is configured for the respective user entity based on the first policy, content of the first resource upper limit field indicates a percentage of a maximum amount of resources which are allowed to be allocated to the respective user entity with respect to the amount of overall resources.

14. The apparatus according to claim 13, further configured to:
in response to receiving a resource allocation request from the user entity, to check a policy field of a quota database record for the user entity so as to determine whether the resource quota for the user entity is configured based on the first policy or the second policy; and
define according, at least in part, to the determination of the resource quota for the user entity is configured based on the first policy or the second policy, whether or not to allocate the requested resource to the user entity.

15. The apparatus according to claim 14, further configured to :
determine according, at least in part, to the first policy, whether or not to allocate the requested resource to the user entity if the resource quota is configured for the user entity based on the first policy.

16. The apparatus according to claim 15, further configured to:
compute a maximum amount of resources which are allowed to be allocated to the user entity, based on content in the first resource upper limit field of the quota database record for the user entity;
computer a sum of current resource usage of the user entity and an amount of the requested resources;
compare the sum with the maximum amount of resources; and
allocate the requested resources to the user entity in response to the sum being not exceeding the maximum amount of resources.

17. The apparatus according to claim 12, wherein the quota database record created for each user entity further comprises a second resource upper limit field for indicating a resource threshold which are allowed to be allocated to a respective user entity.

18. The apparatus according to claim 13, wherein further configured to:
specify a format of a quota report; and
send a quota reporting request to a user entity so as to request the user entity reporting information in the quota database record for the user entity using the specified format.

19. The apparatus according to claim 18, wherein the specified format comprises at least one from the group consisting of:
(i) a percentage format, indicating that the user entity should report content in the identifier field, should use the percentage of the maximum amount of resources which are allowed to be allocated to a respective user entity with respect to the amount of all resources to report content in the first resource upper limit field, and should use the percentage of an amount of resources which have been used by the respective user entity with respect to the amount of all resources to report content in the resource usage field;
(ii) an amount format, indicating the user entity should report content in the identifier field, should use the maximum amount of resources which are allowed to be allocated to the respective user entity to report content in the first resource upper limit field, and should use an amount of resources which have been used by the respective user entity to report content in the resource usage field; and
(iii) a default format, indicating the user entity should report contents in all fields of the quota database record for the user entity.

20. A computer program product, comprising a computer readable medium which carries computer program code embodied therein and for use with a computer, the computer program code comprising:
code for configuring a resource quota for each user entity of a plurality of user entities based on at least one of a first policy or a second policy,
the first policy indicating that the resource quota is to be configured using a percentage of an amount of resources allowed to be configured with respect to an amount of all resources,
the second policy indicating that the resource quota is to be configured using the amount of resources allowed to be configured; and
code for applying the resource quota according to the first policy or the second policy.
